(19) United States
(12) Patent Application Publication
(10) Pub. No.: US 2026/0235447 A1
(43) Pub. Date: Aug. 13, 2026

(54) MULTI-FUNCTIONAL TEMPERATURE MEASURING GUN

(71) Applicant: Guangming LIAO, Shenzhen (CN)

(72) Inventor: Guangming LIAO, Shenzhen (CN)

(21) Appl. No.: 19/069,403

(22) Filed: Mar. 4, 2025

(30) Foreign Application Priority Data
Feb. 8, 2025 (CN) 2025202070394

(51) Int. Cl. G01J 5/08; G01J 5/02; G01J 5/04

(52) U.S. Cl. CPC G01J 5/0846; G01J 5/0205; G01J 5/0265; G01J 5/028; G01J 5/04; G01J 5/0896

(57) ABSTRACT

The present application provides a multi-functional temperature measuring gun and relates to the technical field of temperature measuring guns. The multi-functional temperature measuring gun includes a temperature measuring gun main body, the temperature measuring gun main body includes a housing, a temperature sensor is disposed on the housing, and a temperature measuring probe is further disposed on an outer side of the housing. The temperature sensor is configured to measure a temperature of a surface of an object, the temperature measuring probe is configured to be inserted into the object, to internally measure the object, and a connecting structure is disposed between the temperature measuring probe and the housing. In the present application, the temperature sensor and the temperature measuring probe are disposed.

### CROSS-REFERENCE TO RELATED APPLICATIONS

The application claims priority to Chinese patent application No. 2025202070394, filed on Feb. 8, 2025, the entire contents of which are incorporated herein by reference.

### TECHNICAL FIELD

The present invention relates to the technical field of temperature measuring guns, and specifically to a multi-functional temperature measuring gun.

### BACKGROUND

As a non-contact temperature measuring tool, the traditional temperature measuring gun is widely applied to various fields such as medicine, industry, and food detection. The non-contact design of the traditional temperature measuring gun enables the temperature measuring gun to quickly obtain the temperature information of the surface of the measured object without direct contact, effectively avoiding the risk of contamination or damage that may arise from direct contact. However, this non-contact temperature measuring method also limits the temperature measuring range of the traditional temperature measuring gun, which is mainly limited to the temperature measurement on the object surface.

In practical application, it is necessary to learn about the temperature inside the object in many scenarios, such as in food processing. Since the traditional temperature measuring gun cannot directly be in contact with the inside of the object, the traditional temperature measuring gun cannot meet the need to measure the internal temperature of the object. Therefore, an improvement is made to this, and a multi-functional temperature measuring gun is provided.

### SUMMARY

A purpose of the present invention is to solve a problem that a currently existing non-contact temperature measuring gun design is difficult to meet internal temperature measurement of an object.

To solve the above purpose of the present invention, the present invention provides a multi-functional temperature measuring gun, to improve the above problem.

Specifically, the present application is as follows:

A multi-functional temperature measuring gun, including a temperature measuring gun main body, where the temperature measuring gun main body includes a housing, a temperature sensor is disposed on the housing, a temperature measuring probe is further disposed on an outer side of the housing, the temperature sensor is configured to measure a temperature of a surface of an object, the temperature measuring probe is configured to be inserted into the object, to internally measure the object, and a connecting structure is disposed between the temperature measuring probe and the housing.

As a preferred technical solution of the present application, a control mainboard is further disposed in the housing, the temperature sensor is connected to the control mainboard, and a display screen connected to the control mainboard is disposed on the outer side of the housing; and
a battery compartment connected to the control mainboard is disposed in the housing, a battery main body is disposed in the battery compartment, and a battery cover is disposed between the battery compartment and an outer portion of the housing.

As a preferred technical solution of the present application, a trigger, a laser emitter, and a function button are disposed on the housing, and the trigger, the laser emitter, and the function button are all connected to the control mainboard.

As a preferred technical solution of the present application, the connecting structure includes two protective plates mounted on the housing, an accommodating groove is formed between the two protective plates, and the temperature measuring probe is placed in the accommodating groove.

As a preferred technical solution of the present application, one end of the temperature measuring probe is connected to a connecting base, a connecting shaft is fixedly connected to the connecting base, and each of sides, close to each other, of the two protective plates is provided with a connecting hole that is in inserted connection with the connecting shaft.

As a preferred technical solution of the present application, a front end of the temperature measuring gun main body is provided with a concave groove, the concave groove is communicated with the accommodating groove, and a convex rib is fixedly connected to an inner wall on each of two sides of the concave groove.

As a preferred technical solution of the present application, the connecting structure includes a protective tube fixedly mounted on a top portion of the housing, a sliding block is slidably connected to the protective tube internally, and one end of the temperature measuring probe is connected to the sliding block; and
the protective tube is provided with a sliding slot, one side, close to the sliding slot, of the sliding block is threadedly connected to a first hand bolt, and the first hand bolt passes through the sliding slot and extends out of the protective tube.

As a preferred technical solution of the present application, the connecting structure includes a second hand bolt threadedly connected to a top portion of the housing, a support base is sleeved on an outer surface of the second hand bolt, a first stud is fixedly mounted on one side of the support base, and one side, away from the support base, of the first stud is connected to the temperature measuring probe.

As a preferred technical solution of the present application, an outer surface of the first stud is threadedly connected to an internal threaded tube, and the temperature measuring probe is located in the internal threaded tube.

As a preferred technical solution of the present application, a second stud is fixedly connected to a bottom end of the housing.

Compared with the prior art, beneficial effects of the present invention are as follows:

In the solutions of the present application:

To solve the problem that the non-contact temperature measuring gun design is difficult to meet the internal temperature measurement of the object, in the present application, the temperature sensor and the temperature measuring probe are disposed. The temperature measuring probe can be directly inserted into the object for measurement, and the temperature sensor measures the temperature of the surface of the object, that is, the present application not only retains a non-contact temperature measuring function of a traditional temperature measuring gun, but also adds a contact temperature measuring function, so that a same device can meet more diverse temperature measuring requirements, and a user does not need to carry a plurality of temperature measuring tools.

### BRIEF DESCRIPTION OF THE DRAWINGS

FIG. 1 is a schematic structural diagram of a multi-functional temperature measuring gun according to the present application;

FIG. 2 is an exploded view of FIG. 1 of a multi-functional temperature measuring gun according to the present application;

FIG. 3 is a schematic structural rear view of FIG. 1 according to the present application;

FIG. 4 is a schematic structural partial diagram of FIG. 1 according to the present application;

FIG. 5 is a schematic structural diagram of a multi-functional temperature measuring gun according to the present application;

FIG. 6 is a schematic structural diagram of a sliding slot of a multi-functional temperature measuring gun according to the present application;

FIG. 7 is a schematic structural diagram of a multi-functional temperature measuring gun according to the present application;

FIG. 8 is a schematic structural diagram of a second stud of a multi-functional temperature measuring gun according to the present application;

FIG. 9 is a schematic structural diagram of a first stud of a multi-functional temperature measuring gun according to the present application; and

FIG. 10 is a schematic structural diagram in which an internal threaded tube and a second stud of a multi-functional temperature measuring gun are connected according to the present application.

### REFERENCE NUMERALS IN THE DRAWINGS

1. temperature measuring gun main body; 101. control mainboard; 102. temperature sensor; 103. display screen; 104. function button; 105. laser emitter; 106. battery compartment; 107. battery main body; 108. trigger; 109. battery cover; 110. housing; 2. temperature measuring probe; 3. protective plate; 301. connecting hole; 302. connecting shaft; 303. connecting base; 4. concave groove; 401. convex rib; 5. protective tube; 501. sliding slot; 502. sliding block; 503. first hand bolt; 6. support base; 601. second hand bolt; 602. first stud; 603. internal threaded tube; 604. second stud.

### DETAILED DESCRIPTION OF THE EMBODIMENTS

In order to enable a person skilled in the art to better understand the technical solutions of the present invention, the technical solutions in the embodiments of the present invention are clearly and completely described below with reference to the accompanying drawings in the embodiments of the present invention. Apparently, the described embodiments are only some rather than all of the embodiments of the present invention. All other embodiments obtained by those of ordinary skill in the art based on the embodiments of the present invention without creative efforts shall fall within the protection scope of the present invention.

It should be noted that, without conflict, the embodiments and features and technical solutions in the embodiments of the present invention may be combined with each other.

It should be noted that similar reference numerals and letters refer to similar items in the following accompanying drawings, and therefore, once an item is defined in one accompanying drawing, it is not necessary to further define and explain the item in the subsequent accompanying drawings.

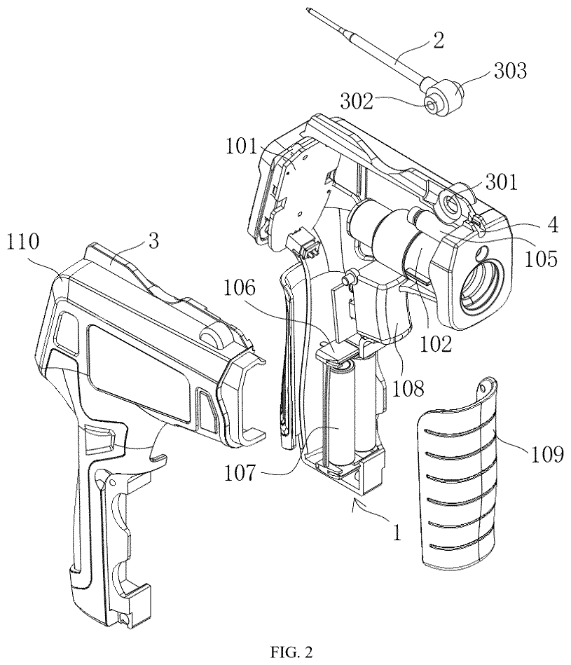

Embodiment 1: Referring to FIG. 2, a multi-functional temperature measuring gun includes a temperature measuring gun main body 1, the temperature measuring gun main body 1 includes a housing 110, a temperature sensor 102 is disposed on the housing 110, a temperature measuring probe 2 is further disposed on an outer side of the housing 110, the temperature sensor 102 is configured to measure a temperature of a surface of an object, the temperature measuring probe 2 is configured to be inserted into the object, to internally measure the object, and a connecting structure is disposed between the temperature measuring probe 2 and the housing 110. The present application not only retains a non-contact temperature measuring function of a traditional temperature measuring gun, but also adds a contact temperature measuring function, so that a same device can meet more diverse temperature measuring requirements, and a user does not need to carry a plurality of temperature measuring tools.

Further, as shown in FIG. 2, a control mainboard 101 is further disposed in the housing 110, the temperature sensor 102 is connected to the control mainboard 101, and a display screen 103 connected to the control mainboard 101 is disposed on the outer side of the housing 110; and
a battery compartment 106 connected to the control mainboard 101 is disposed in the housing 110, a battery main body 107 is disposed in the battery compartment 106, a battery cover 109 is disposed between the battery compartment 106 and an outer portion of the housing 110, and the battery main body 107 is configured to provide required electric energy for an overall operation.

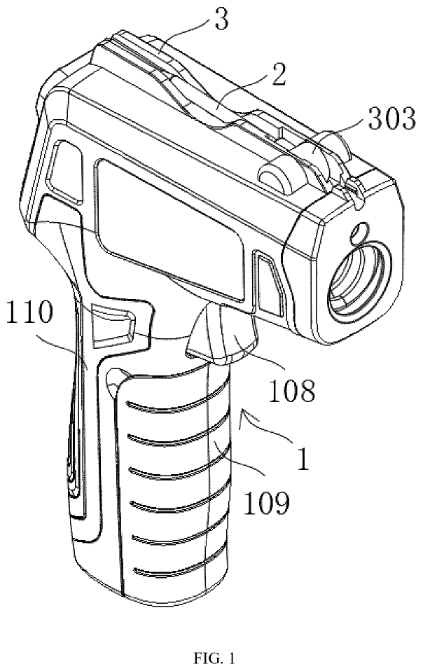

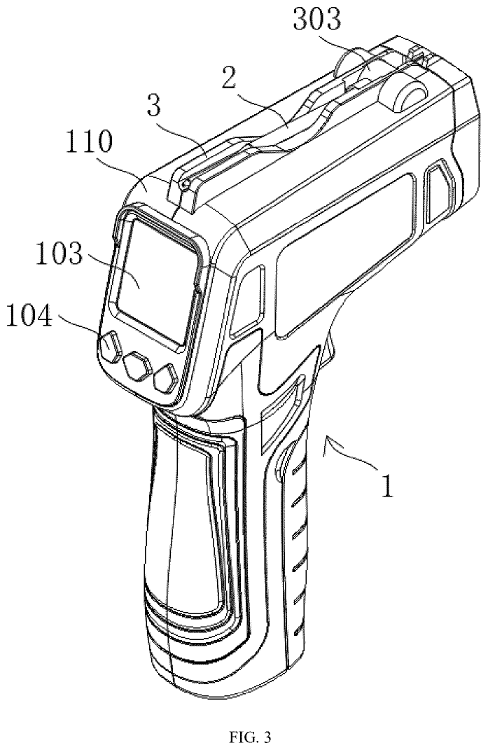

Further, as shown in FIG. 1 to FIG. 3, a trigger 108, a laser emitter 105, and a function button 104 are disposed on the housing 110, the trigger 108, the laser emitter 105, and the function button 104 are all connected to the control mainboard 101, and the laser emitter 105 is configured to emit laser, to indicate a position at which the temperature sensor 102 is aimed during temperature measurement, to facilitate use of a worker.

The temperature measuring probe 2 is inserted into the object to measure an internal temperature of the object, and the temperature sensor 102 performs non-contact measurement. Data measured by the temperature sensor 102 and the temperature measuring probe 2 is transmitted to the control mainboard 101, and the control mainboard 101 controls the display screen 103 to display the data.

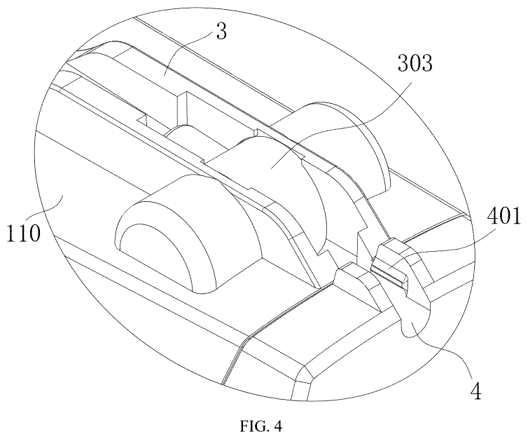

Embodiment 2: The multi-functional temperature measuring gun provided in Embodiment 1 is further optimized. Specifically, as shown in FIG. 1 to FIG. 4, the connecting structure includes two protective plates 3 mounted on the housing 110, an accommodating groove is formed between the two protective plates 3, and the temperature measuring probe 2 is placed in the accommodating groove. Middle portions of the protective plates 3 are recessed, and recessed portions provide space for a hand portion when the user operates the temperature measuring probe 2.

Further, one end of the temperature measuring probe 2 is connected to a connecting base 303, a connecting shaft 302 is fixedly connected to the connecting base 303, and each of sides, close to each other, of the two protective plates 3 is provided with a connecting hole 301 that is in inserted connection with the connecting shaft 302. Two sides of the connecting base 303 are in contact with the two protective plates 3 respectively. The protective plates 3 are limited by using a friction force between the connecting base 303 and the protective plates 3 and a friction force between the connecting shaft 302 and the connecting hole 301, to reduce self-rotation of the protective plates 3, thereby reducing self-rotation of the temperature measuring probe 2.

Further, a front end of the temperature measuring gun main body 1 is provided with a concave groove 4, the concave groove 4 is communicated with the accommodating groove, and a convex rib 401 is fixedly connected to an inner wall on each of two sides of the concave groove 4. During use, the temperature measuring probe 2 rotates to be inserted into the concave groove 4, and the temperature measuring probe 2 is squeezed between two convex ribs 401, so that the temperature measuring probe 2 is limited through the two convex ribs 401, to improve stability of the temperature measuring probe 2, thereby facilitating inserting the temperature measuring probe 2 into a to-be-measured object.

When the temperature measuring probe 2 is used, referring to FIG. 1, fingers of the user pinch the temperature measuring probe 2 from the recessed portions of the protective plates 3 and rotate with the connecting shaft 302 as a center, to enable the temperature measuring probe 2 to be inserted into the concave groove 4. Then the temperature measuring probe 2 is inserted into the to-be-measured object for measurement, a temperature measured by the temperature measuring probe 2 is transmitted to the control mainboard 101, and the control mainboard 101 controls the display screen 103 to display the data. After use, the temperature measuring probe 2 is cleaned and then rotated back to the accommodating groove that is between the two protective plates 3.

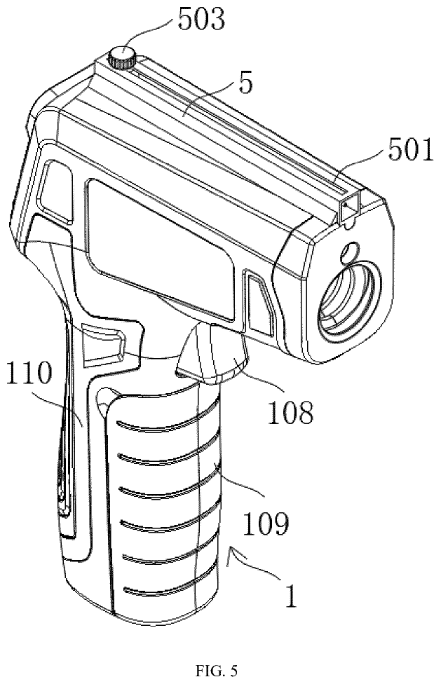

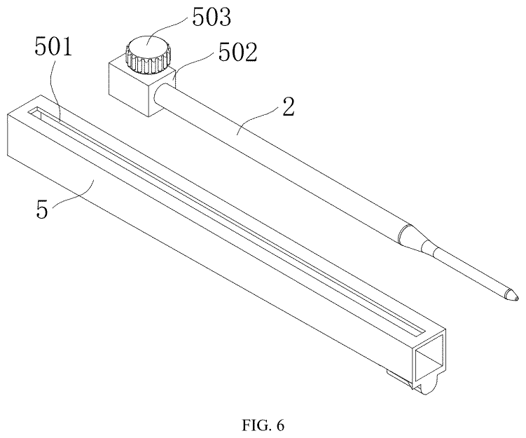

Embodiment 3: the multi-functional temperature measuring gun provided in Embodiment 1 is further optimized. Specifically, as shown in FIG. 5 and FIG. 6, the connecting structure includes a protective tube 5 fixedly mounted on a top portion of the housing 110, a sliding block 502 is slidably connected to the protective tube 5 internally, and one end of the temperature measuring probe 2 is connected to the sliding block 502. The protective tube 5 can protect the temperature measuring probe 2, to reduce damage to the temperature measuring probe 2 in a non-use state due to collision.

The protective tube 5 is provided with a sliding slot 501, one side, close to the sliding slot 501, of the sliding block 502 is threadedly connected to a first hand bolt 503, and the first hand bolt 503 passes through the sliding slot 501 and extends out of the protective tube 5.

The temperature measuring probe 2 is used, referring to FIG. 5 and FIG. 6, the first hand bolt 503 is unscrewed, and the first hand bolt 503 is pushed to drive the sliding block 502 and the temperature measuring probe 2 to move, so that the temperature measuring probe 2 can extend out from the protective tube 5. Then the first hand bolt 503 is screwed to fix a position of the sliding block 502, to fix a position of the temperature measuring probe 2. The temperature measuring probe 2 is inserted into a to-be-measured object to measure the internal temperature of the object. After use, the temperature measuring probe 2 is cleaned and then pushed back into the protective tube 5.

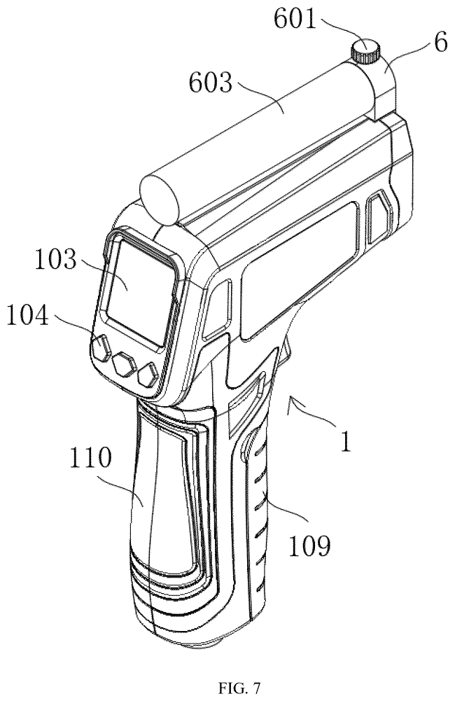

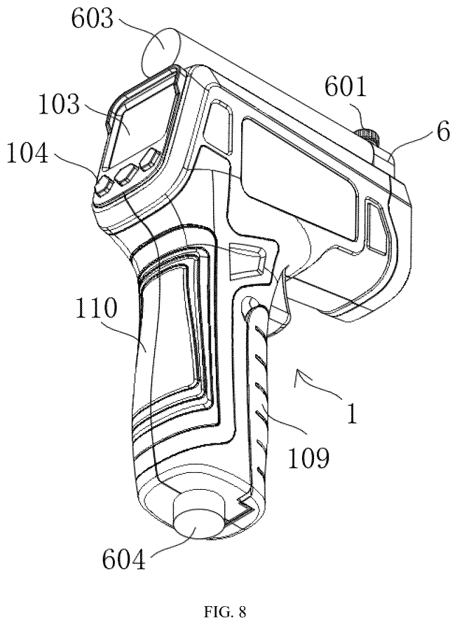

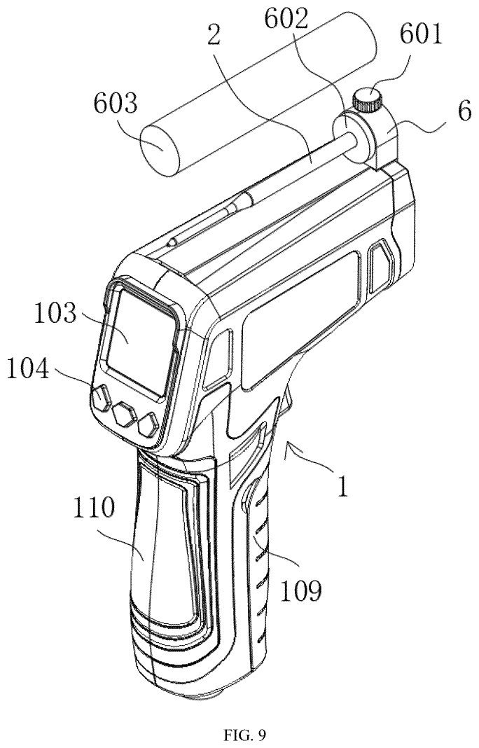

Embodiment 4: The multi-functional temperature measuring gun provided in Embodiment 1 is further optimized. Specifically, as shown in FIG. 7 to FIG. 9, the connecting structure includes a second hand bolt 601 threadedly connected to a top portion of the housing 110, a support base 6 is sleeved on an outer surface of the second hand bolt 601, a first stud 602 is fixedly mounted on one side of the support base 6, and one side, away from the support base 6, of the first stud 602 is connected to the temperature measuring probe 2. The support base 6 may be rotated after the second hand bolt 601 is unscrewed, thereby adjusting a position of the temperature measuring probe 2.

Further, an outer surface of the first stud 602 is threadedly connected to an internal threaded tube 603, the temperature measuring probe 2 is located in the internal threaded tube 603, and the internal threaded tube 603 is configured to protect the temperature measuring probe 2 in a non-use state.

Further, a second stud 604 is fixedly connected to a bottom end of the housing 110, and the internal threaded tube 603 may be connected to the second stud 604 after being separated from the first stud 602. On one hand, the loss of the internal threaded tube 603 may be reduced, and on the other hand, the internal threaded tube 603 may be used as an extended handle of the temperature measuring gun main body 1 for use, so that a hand portion of the user may be further away from a to-be-measured object when the temperature measuring probe 2 is used for temperature measurement.

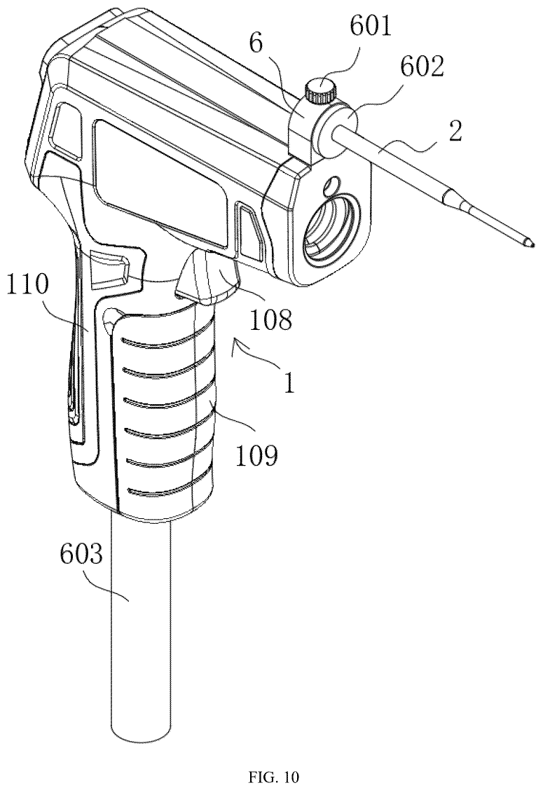

When the temperature measuring probe 2 is used, referring to FIG. 7, the second hand bolt 601 is unscrewed, the support base 6 is rotated one hundred and eighty degrees with the second hand bolt 601 as a center, then the second hand bolt 601 is screwed, the internal threaded tube 603 is rotated to enable the internal threaded tube 603 to be separated from the first stud 602, and the internal threaded tube 603 is connected to an outer surface of the second stud 604, which is as shown in FIG. 10. At this time, the user may hold the housing 110 or the internal threaded tube 603 and insert the temperature measuring probe 2 into the to-be-measured object for temperature measurement. After use, the temperature measuring probe 2 is cleaned, the internal threaded tube 603 is connected to the first stud 602 after being separated from the second hand bolt 601, the second hand bolt 601 is unscrewed, and the support base 6 is reversely rotated one hundred and eighty degrees with the second hand bolt 601 as the center, that is, a form of the present application is switched from FIG. 10 to FIG. 7.

In the present invention, unless otherwise expressly specified and defined, the terms “mounted”, “attached”, “connected”, “fixed”, and the like should be understood in a broad sense, for example, a connection may be a fixed connection, a detachable connection, or an integral connection; it may be a mechanical connection, an electrical connection, or a communication between each other; it may be a direct connection or an indirect connection via an intermediate medium; and it may be a connection between two elements or an interaction between two elements, unless otherwise expressly defined. Those of ordinary skill in the art can understand specific meanings of the terms in the present invention according to specific situations.

Apparently, the embodiments described above are merely some rather than all of the embodiments of the present invention, and the accompanying drawings show preferred embodiments of the present invention, but do not limit the patent scope of the present invention. The present invention may be implemented in a plurality of different forms. On the contrary, these embodiments are provided to facilitate a more thorough and comprehensive understanding of the disclosure of the present invention. Although the present invention is described in detail with reference to the foregoing embodiments, a person skilled in the art can still modify the technical solutions described in the foregoing embodiments or equivalently replace some of the technical features therein. Any equivalent structure made by using the contents of the specification and the accompanying drawings of the present invention, or directly or indirectly applied to other related technical fields, is similarly included in the protection scope of the patent of the present invention.

What is claimed is:

1. A multi-functional temperature measuring gun, comprising a temperature measuring gun main body (1), wherein the temperature measuring gun main body (1) comprises a housing (110), a temperature sensor (102) is disposed on the housing (110), a temperature measuring probe (2) is further disposed on an outer side of the housing (110), the temperature sensor (102) is configured to measure a temperature of a surface of an object, the temperature measuring probe (2) is configured to be inserted into the object, to internally measure the object, and a connecting structure is disposed between the temperature measuring probe (2) and the housing (110).

2. The multi-functional temperature measuring gun according to claim 1, wherein a control mainboard (101) is further disposed in the housing (110), the temperature sensor (102) is connected to the control mainboard (101), and a display screen (103) connected to the control mainboard (101) is disposed on the outer side of the housing (110); and
a battery compartment (106) connected to the control mainboard (101) is disposed in the housing (110), a battery main body (107) is disposed in the battery compartment (106), and a battery cover (109) is disposed between the battery compartment (106) and an outer portion of the housing (110).

3. The multi-functional temperature measuring gun according to claim 2, wherein a trigger (108), a laser emitter (105), and a function button (104) are disposed on the housing (110), and the trigger (108), the laser emitter (105), and the function button (104) are all connected to the control mainboard (101).

4. The multi-functional temperature measuring gun according to claim 1, wherein the connecting structure comprises two protective plates (3) mounted on the housing (110), an accommodating groove is formed between the two protective plates (3), and the temperature measuring probe (2) is placed in the accommodating groove.

5. The multi-functional temperature measuring gun according to claim 4, wherein one end of the temperature measuring probe (2) is connected to a connecting base (303), a connecting shaft (302) is fixedly connected to the connecting base (303), and each of sides, close to each other, of the two protective plates (3) is provided with a connecting hole (301) that is in inserted connection with the connecting shaft (302).

6. The multi-functional temperature measuring gun according to claim 5, wherein a front end of the temperature measuring gun main body (1) is provided with a concave groove (4), the concave groove (4) is communicated with the accommodating groove, and a convex rib (401) is fixedly connected to an inner wall on each of two sides of the concave groove (4).

7. The multi-functional temperature measuring gun according to claim 1, wherein the connecting structure comprises a protective tube (5) fixedly mounted on a top portion of the housing (110), a sliding block (502) is slidably connected to the protective tube (5) internally, and one end of the temperature measuring probe (2) is connected to the sliding block (502); and
the protective tube (5) is provided with a sliding slot (501), one side, close to the sliding slot (501), of the sliding block (502) is threadedly connected to a first hand bolt (503), and the first hand bolt (503) passes through the sliding slot (501) and extends out of the protective tube (5).

8. The multi-functional temperature measuring gun according to claim 1, wherein the connecting structure comprises a second hand bolt (601) threadedly connected to a top portion of the housing (110), a support base (6) is sleeved on an outer surface of the second hand bolt (601), a first stud (602) is fixedly mounted on one side of the support base (6), and one side, away from the support base (6), of the first stud (602) is connected to the temperature measuring probe (2).

9. The multi-functional temperature measuring gun according to claim 8, wherein an outer surface of the first stud (602) is threadedly connected to an internal threaded tube (603), and the temperature measuring probe (2) is located in the internal threaded tube (603).

10. The multi-functional temperature measuring gun according to claim 9, wherein a second stud (604) is fixedly connected to a bottom end of the housing (110).
